(19) United States
(12) Patent Application Publication
(10) Pub. No.: US 2006/0154502 A1
(43) Pub. Date: Jul. 13, 2006

(54) Adapter nut

(76) Inventor: Cosmo Castaldo, Westbury, NY (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/298,708

(22) Filed: Dec. 12, 2005

Related U.S. Application Data
(60) Provisional application No. 60/637,227, filed on Dec. 17, 2004.

(51) Int. Cl. H01R 13/44

(52) U.S. Cl. 439/131

(57) ABSTRACT

The adapter assembly in accordance with the present invention is threaded internally at each end and allows back-to-back coupling of a plug and a cord connector while providing a completely weather-tight seal. Six different sizes of the adapter nuts are available to allow coupling of different size plugs. A Wetguard™ adapter assembly is a solid item from one end to the other with a single adapter nut holding both an existing Wetguard™ plug and connector rigidly at each end. Moreover, this assembly may comprise a plug compatible with the existing line of Wetguard™ plugs.

### CROSS-REFERENCE TO RELATED APPLICATIONS

This application claims the benefit of the filing date of a provisional application having Ser. No. 60/637,227, which was filed on Dec. 17, 2004.

### FIELD OF THE INVENTION

The present invention relates to an adapter nut for interconnecting a plug and a connector.

### BACKGROUND OF THE INVENTION

Indoor and outdoor use of electrical equipment tends to be complicated by the exterior elements of weather. Leviton Manufacturing Company provides a series of products, trademarked Wetguard™, which serve a dual purpose of protecting the user from incidental contact with the enclosed electrical equipment and protecting the enclosed equipment against specified environmental conditions. Specifically, Wetguard devices, such as plugs, connectors, and receptacles, for indoor and outdoor use, provide a degree of protection against windblown dust and rain, splashing water, and hose directed water. In addition these devices may provide a degree of protection against corrosion resulting from approximately 200 hours of exposure to salt fog spray. Moreover, some of the devices provide a degree of protection from temporary submersion at a limited depth and damage from external ice formation.

Specifically, when-camping outdoors or boating, there is often a need for an electrical appliance which must receive electrical power from an electrical distribution system. As such, Wetguard adapters exist which may couple electrical cords of boating and camping equipment to an electrical distribution system. These adapters convert an existing outlet into a desired National Electrical Manufacturers Association (NEMA) configuration. These type of adapters are very popular around marinas and campgrounds where there is often mismatched plug configurations. These adapters couple electrical cords of different configurations without necessitating any rewiring. The mismatched plug configurations often include large current rated plugs which have larger body diameters that must be coupled to smaller current rated electrical outlets. These types of adapters, however, provide waterproof access to electrical power only on a temporary basis. Yet, there are instances where prolonged usage may be necessary. Thereby, the foregoing series of adapters would not be suitable for this type of prolonged usage.

Other adapters on the market include complicated designs that are not waterproof. Thus, there is a need for a waterproof adapter that does not include a cumbersome nor complex design. Furthermore, since mismatched plug configurations exist, there is a need for not just one size but for several different sizes that allow the coupling of different size plugs and connectors.

### SUMMARY OF THE INVENTION

To address the above-discussed deficiencies of adapter assemblies, the present invention teaches a waterproof adapter nut for an adapter assembly that couples a plug and a connector that enables access to power for a prolonged period of time. The adapter assembly including the adapter nut in accordance with the present invention is a solid item from one end to the other with a single adapter nut holding both the plug and connector rigidly at each end. The adapter nut is threaded internally at each end and allows back-to-back coupling of a plug and cord connector while providing a completely weather-tight seal. Six different sizes of the adapter nuts are available to allow coupling of different size plugs. Plugs may be selected from the existing line of Wetguard plugs or compatible plugs.

Specifically, the adapter nut includes a first opening sized to accept one end of a male-plug and a second opening sized to accept one end of a female-connector. The first opening of the waterproof adapter nut may include threads at least on its interior surface for connection to a threaded plug. The second opening of the waterproof adapter nut may includes thread at least on its interior surface for connection to a threaded connector.

An embodiment of an adapter assembly of the present invention includes a plug having an attached power cable that extends through the waterproof adapter nut in accordance with the present invention. The waterproof nut includes a first opening sized to accept one end of a plug and a second opening sized to accept one end of a connector. The first opening of the waterproof adapter nut may include threads at least on its interior surface for connection to a threaded plug. The second opening of the waterproof adapter nut may includes thread at least on its interior surface for connection to a threaded connector. The power cable extends through the connector and couples to the receptacle. This adapter assembly including the adapter nut, the plug, the power cable, the connector and the receptacle forms one solid assembly from one end to the other with a single adapter nut holding both the plug and connector rigidly at each end.

These and other features and advantages of the present invention will be understood upon consideration of the following detailed description of the invention and the accompanying drawings.

### BRIEF DESCRIPTION OF THE DRAWINGS

For a more complete understanding of the present invention and the advantages thereof, reference is now made to the following description taken in conjunction with the accompanying drawings in which like reference numbers indicate like features and wherein:

FIG. 1 shows a first embodiment of an adapter assembly using an adapter nut for interconnecting an electrical plug and an electrical connector;

FIG. 2 shows a second embodiment of an adapter assembly using an adapter nut for interconnecting an electrical plug and an electrical connector;

FIGS. 3A-3G show a first embodiment of an adapter nut for interconnecting a electrical plug and an electrical connector;

FIGS. 4A-4G show a second embodiment of an adapter nut for interconnecting a electrical plug and an electrical connector;

FIGS. 5A-5G show a third embodiment of an adapter nut for interconnecting a electrical plug and an electrical connector;

FIGS. 6A-6G show a fourth embodiment of an adapter nut for interconnecting a electrical plug and an electrical connector;

FIGS. 7A-7G show a fifth embodiment of an adapter nut for interconnecting a electrical plug and an electrical connector; and

FIGS. 8A-8G show a sixth embodiment of an adapter nut for interconnecting a electrical plug and an electrical connector.

### DETAILED DESCRIPTION

The present invention will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The adapter assembly including the adapter nut in accordance with the present invention is a solid item from one end to the other with a single adapter nut holding both the plug and connector rigidly at each end. The adapter nut is threaded internally at each end and allows back-to-back coupling of a plug, such as an existing Wetguard plug, and cord connector while providing a completely weather-tight seal. Six different sizes of the adapter nuts are available to allow coupling of different size plugs.

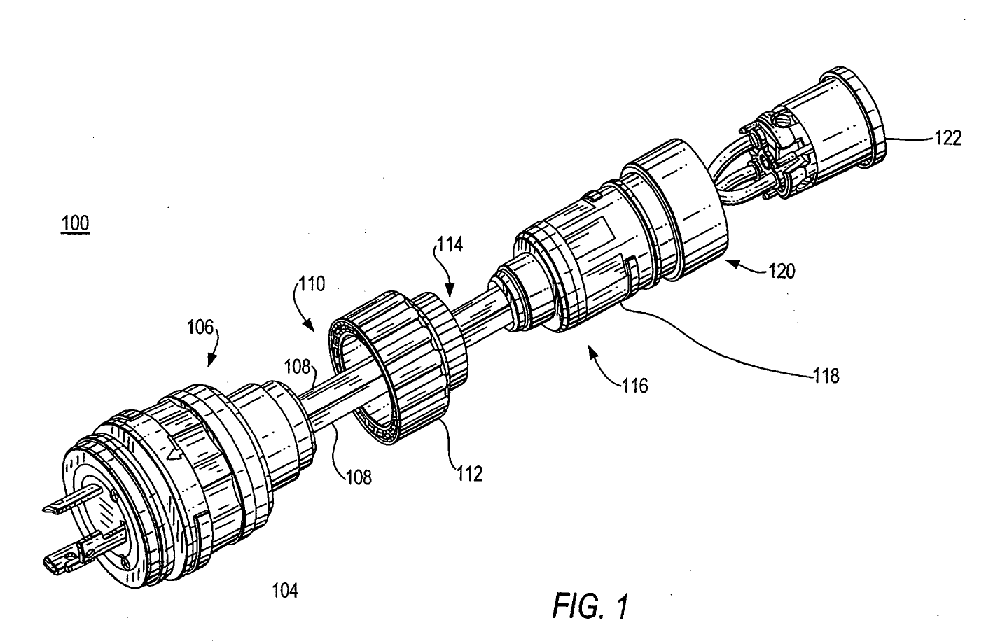

FIG. 1 shows an exploded view of a first embodiment of an adapter assembly 100 using an adapter nut 112 that provides an improved water-tight connection between an electrical plug 104 and an electrical connector 118. Wetguard adapter nut 112 allows emergency interconnection using a single part between any Wetguard NEMA configuration while maintaining all watertight properties. Specifically, adapter nut 112 has a first opening 110 sized to accept the non-blade end 106 of a plug 104 and a second opening 114 sized to accept the non-receptacle end 116 of the connector 118. A power cable 108 includes power conductors—phase P108, neutral N108 and ground G108. Power cable 108 provides an electrical connection between the plug 104, the connector 118 and receptacle 122. The conductors, P108, N108 and G108, at one end of the power cable 108 are connected to terminals at the plug 104 and the conductors, P108, N108 and G108, at the other end of the power cable 108 are connected to terminals at the receptacle 122. In one example, the plug 104 shown is a locking plug with three blades having a current capacity rating of 30 Amps. This plug 104 is intended to be connected to a receptacle 122 having a current rating of 30 Amps. On the other hand, the connector 118 has a current capacity rating of 15 Amps and is intended to accept a plug 104 having a current capacity rating of 15 Amps (not shown). Thus, the adapter nut 112 is part of an adapter assembly 100 allowing a user to connect to an alternating current (AC) power source from a 30 Amp receptacle using a 15 Amp plug without requiring any rewiring of the receptacle 122. Although the plug 104 and receptacle 122 above have been described as a locking plug, the present invention is not limited to such a plug type. For example, the present invention is also applicable with other plug and connector types such as a straight blade type device as well as devices having the same or different current capacity.

The adapter nut 112 can have a thread coupling means to help provide a watertight and/or weather-tight connection between the plug 104 and the connector 118. For example, the first opening 110 can have an inner dimension and thread pattern that complements the external thread pattern of the plug 104. Likewise, the second opening 114 can have an inner dimension and thread pattern that complements the external thread pattern of the non-receptacle end 116 of connector 118. Although a threaded pattern is shown as a means of coupling a plug 104 and a connector 118, other coupling means can be used such as adhesive and other techniques known in the art. In addition, it should be noted that an excess length of cable 108 is shown for illustrative purposes and that the excess cable 108 can be removed so to provide a solid or rigid assembly that helps maintain a watertight assembly.

The adapter assembly 100 formed with the adapter nut 112 can be used in various applications. For example, the adapter 100 can be useful at marinas and campgrounds where there is often a mismatch between plugs and receptacles. In that case, the adapter can provide access to a power from a receptacle without requiring any rewiring of the receptacle.

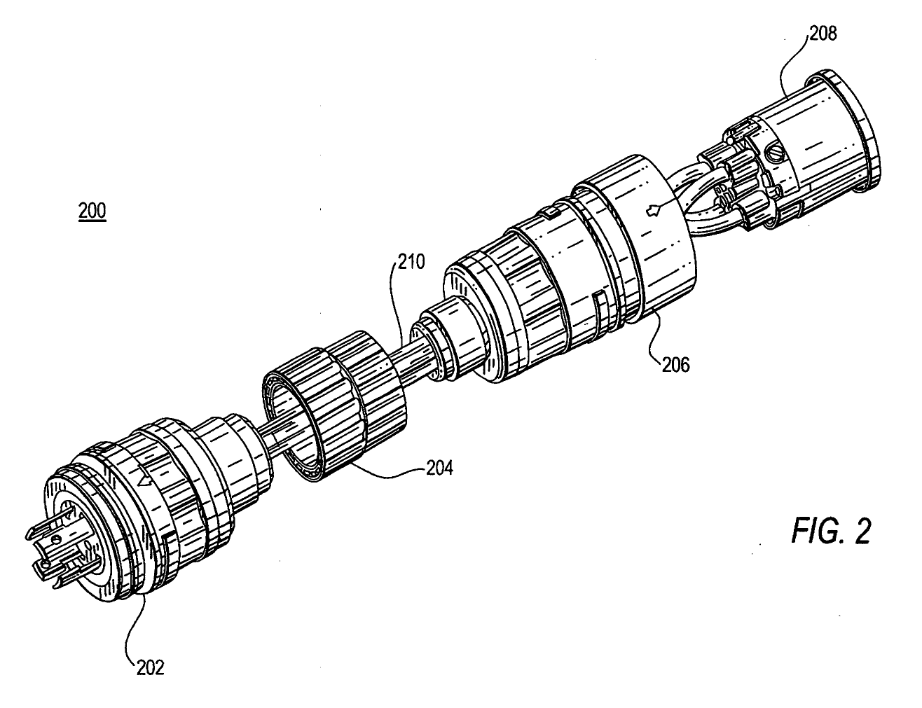

FIG. 2 shows a second embodiment of an assembly 200 using an adapter nut 204 for interconnecting an electrical plug 202 and an electrical connector 206. The assembly 200 of FIG. 2 is similar to the assembly 100 of FIG. 1 except that the adapter nut 204 of FIG. 2 interconnects a connector 206 having a current rating of 20 Amps to a 4-blade plug having a rating of 30 Amps. In this embodiment, the adapter assembly 200 allows a user to connect to an AC power source from a 30 Amp receptacle using a 20 Amp plug without requiring any rewiring of the receptacle.

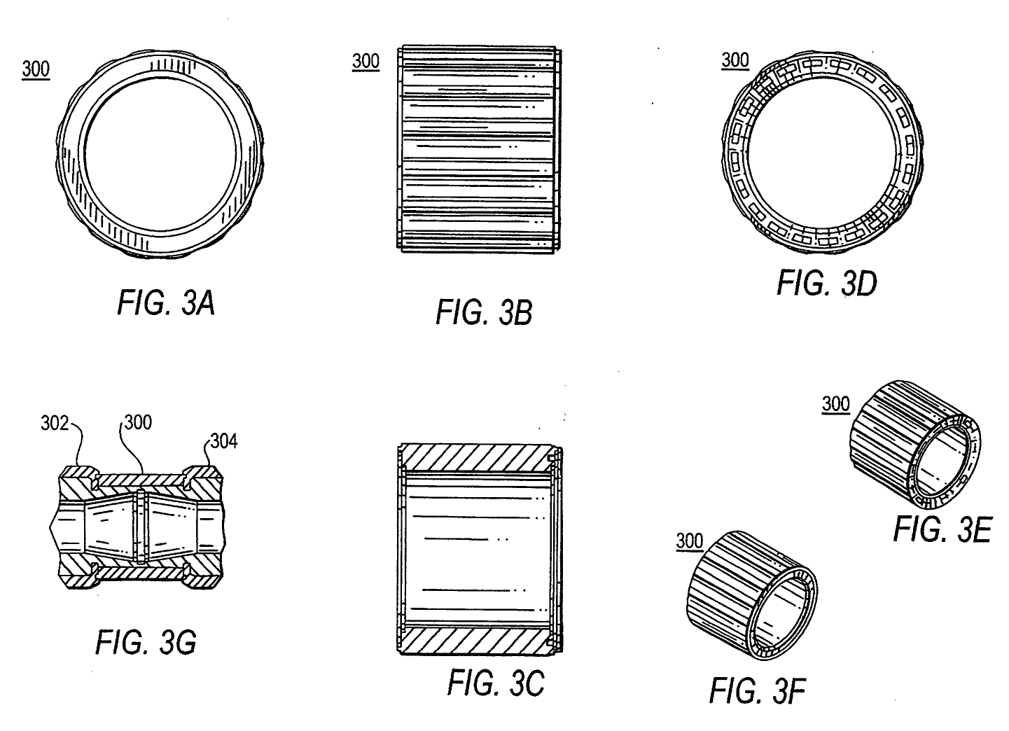

FIGS. 3A-3G show various views of a first embodiment of an adapter nut 300 for interconnecting an electrical plug and an electrical connector. In this embodiment, the adapter assembly 300 allows a user to connect to an AC power source from a 30 Amp receptacle using a 30 Amp plug without requiring any rewiring of the receptacle. In particular, the adapter nut 300 is configured to interconnect a 30 Amp plug to a 30 Amp connector. FIG. 3A shows a front view of the adapter nut and FIG. 3D shows a rear view of the adapter nut 300. FIG. 3B shows a side view of the adapter nut 300 and FIG. 3C shows a cross-section view of FIG. 3B taken along Section line A-A. FIGS. 3E and 3F show perspective views of the adapter nut 300. FIG. 3G shows an adapter nut 300 connecting a plug 302 and connector 304 providing a rigid, watertight assembly.

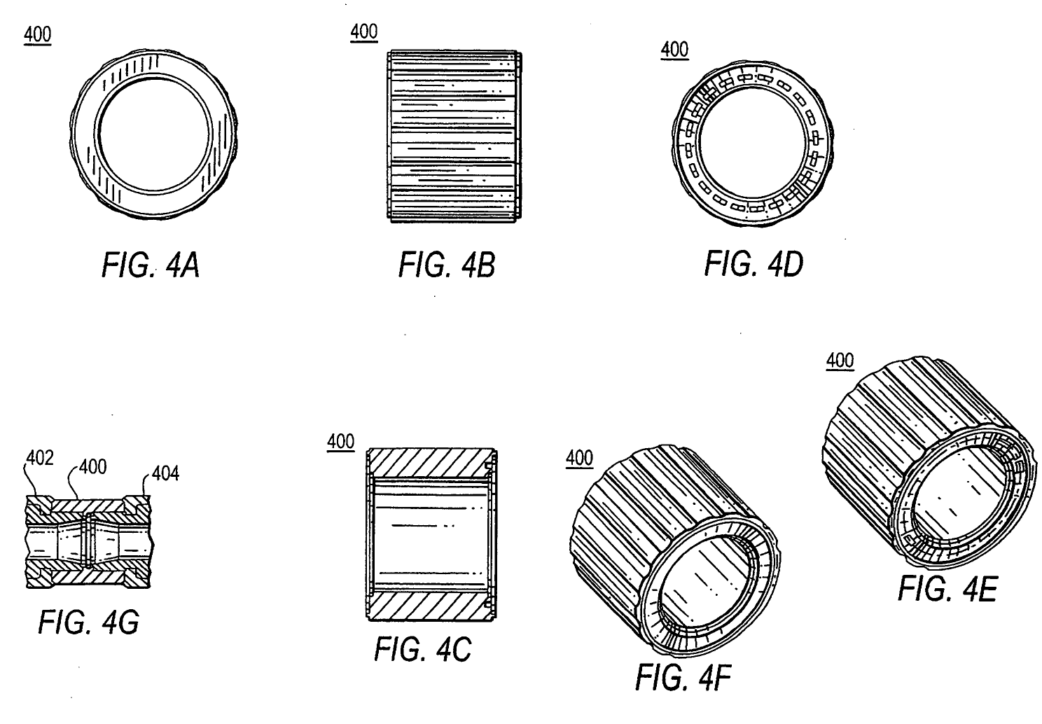

FIGS. 4A-4G show various views of a first embodiment of an adapter nut 400 for interconnecting a electrical plug 402 and an electrical connector 404. In this embodiment, the adapter assembly 400 allows a user to connect to an AC power source from a 15 Amp receptacle using a 15 Amp plug without requiring any rewiring of the receptacle. In particular, the adapter nut 400 is configured to interconnect a 15 Amp plug 402 to a 15 Amp connector 404. FIG. 4A shows a front view of the adapter nut and FIG. 4D shows a rear view of the adapter nut 400. FIG. 4B shows a side view of the adapter nut 400 and FIG. 4C shows a cross-section view of FIG. 4B taken along Section line A-A. FIGS. 4E and 4F show perspective views of the adapter nut 400. FIG. 4G shows an adapter nut 400 connecting a plug 402 and connector 404 providing a rigid, watertight assembly.

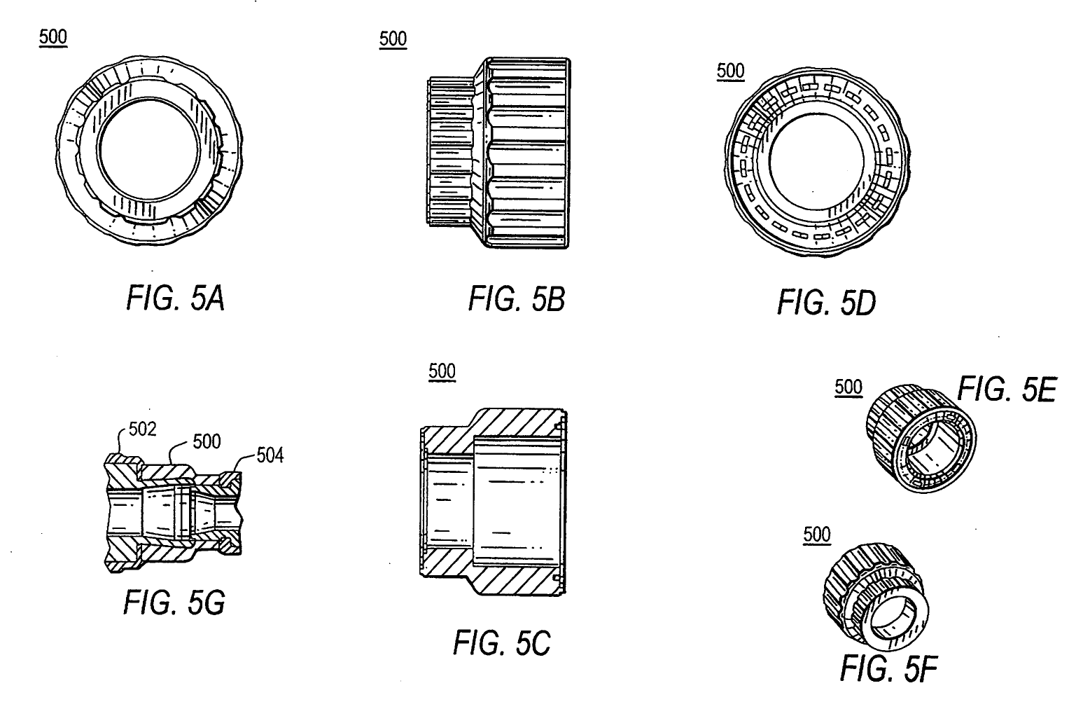

FIGS. 5A-5G show various views of a second embodiment of an adapter nut 500 for interconnecting a electrical plug 502 and an electrical connector 504. The adapter nut 500 is configured to interconnect a 15 Amp plug 502 to a 20 Amp connector 504. Accordingly, the adapter assembly 500 allows a user to connect to an AC power source from a 20 Amp receptacle using a 15 Amp plug without requiring any rewiring of the receptacle. FIG. 5A shows a front view of the adapter nut and FIG. 5D shows a rear view of the adapter nut 500. FIG. 5B shows a side view of the adapter nut 500 and FIG. 5C shows a cross-section view of FIG. 5B taken along Section line A-A. FIGS. 5E and 5F show perspective views of the adapter nut 500. FIG. 5G shows an adapter nut 500 connecting a plug 502 and connector 504 providing a rigid, watertight assembly.

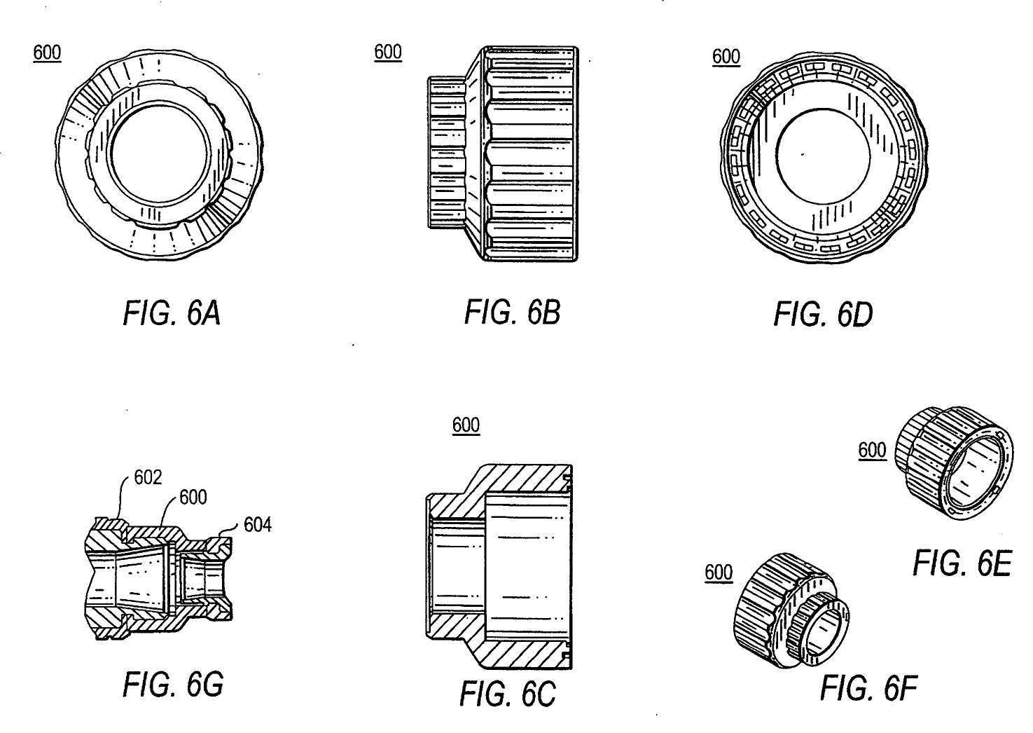

FIGS. 6A-6G show various views of a third embodiment of an adapter nut 600 for interconnecting a electrical plug 602 and an electrical connector 604. The adapter nut 600 is configured to connect a 15 Amp plug 602 to a 30 Amp connector 604. Accordingly, the adapter assembly 600 allows a user to connect to an AC power source from a 30 Amp receptacle using a 15 Amp plug without requiring any rewiring of the receptacle. FIG. 6A shows a front view of the adapter nut and FIG. 6D shows a rear view of the adapter nut 300. FIG. 6B shows a side view of the adapter nut 600 and FIG. 6C shows a cross-section view of FIG. 6B taken along Section line A-A. FIGS. 6E and 6F show perspective views of the adapter nut 600. FIG. 6G shows an adapter nut 600 connecting a plug 602 and connector 604 providing a rigid, watertight assembly.

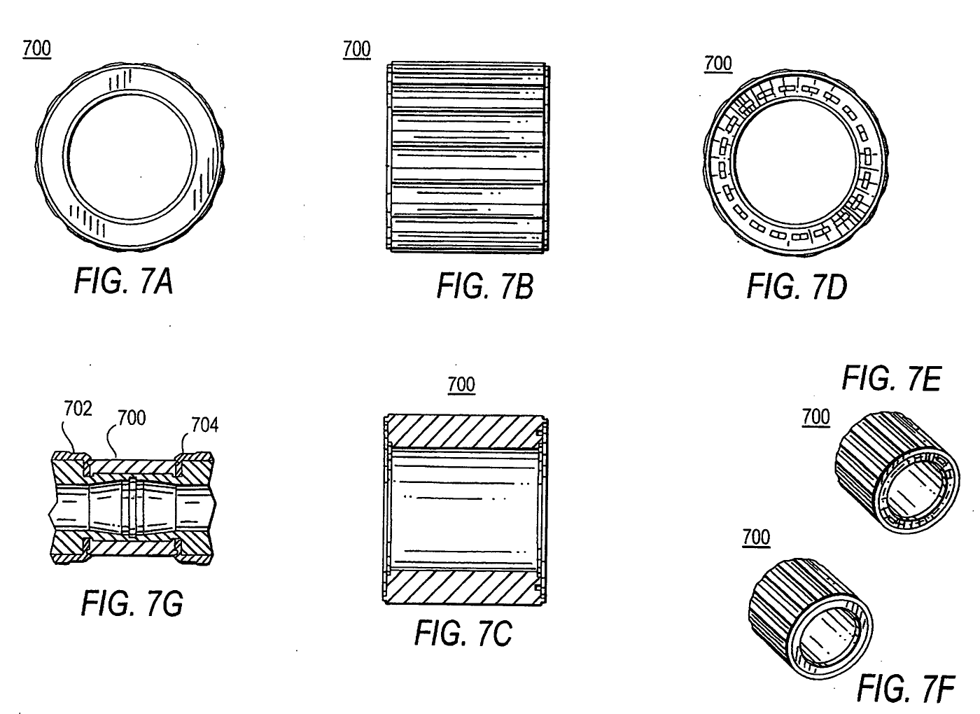

FIGS. 7A-7G show various views of a fourth embodiment of an adapter nut 700 for interconnecting a electrical plug 702 and an electrical connector 704. The adapter nut 700 is configured to connect a 20 Amp plug 702 to a 20 Amp connector 704. Accordingly, the adapter assembly 700 allows a user to connect to an AC power source from a 20 Amp receptacle using a 20 Amp plug without requiring any rewiring of the receptacle. FIG. 7A shows a front view of the adapter nut and FIG. 7D shows a rear view of the adapter nut 700. FIG. 7B shows a side view of the adapter nut 700 and FIG. 7C shows a cross-section view of FIG. 7B taken along Section line A-A. FIGS. 7E and 7F show perspective views of the adapter nut 700. FIG. 7G shows an adapter nut 700 connecting a plug 702 and connector 704 providing a rigid, watertight assembly.

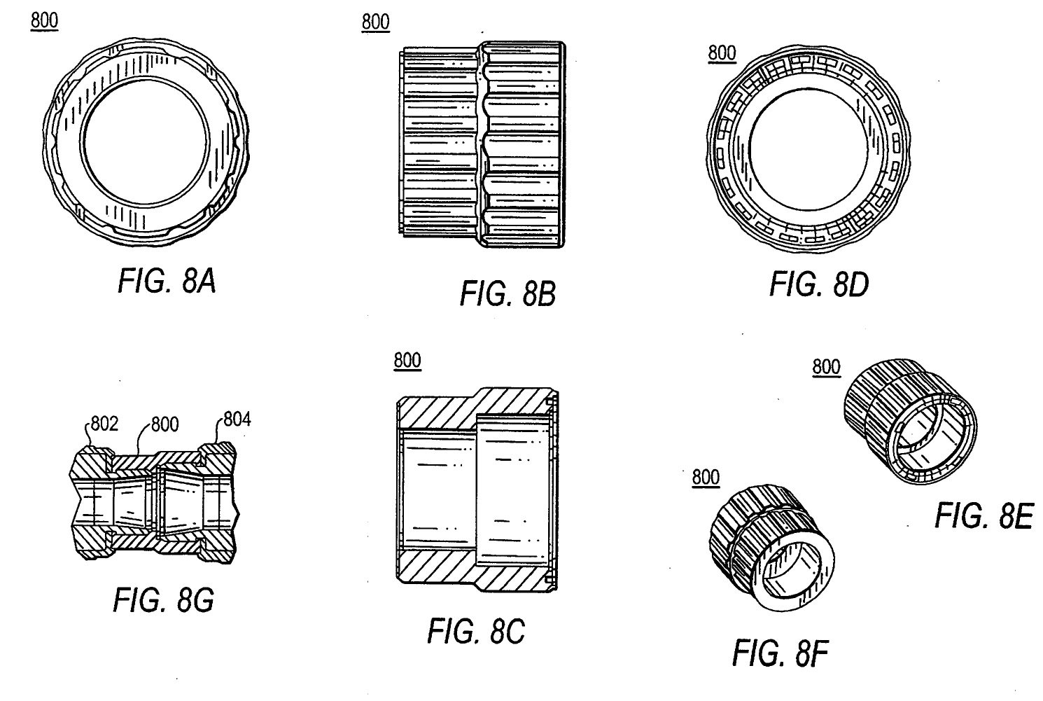

FIGS. 8A-8G show various views of a fifth embodiment of an adapter nut 800 for interconnecting a electrical plug 802 and an electrical connector 804. In this embodiment, the adapter assembly 800 allows a user to connect to an AC power source from a 30 Amp receptacle using a 20 Amp plug without requiring any rewiring of the receptacle. In particular, the adapter nut 800 is configured to connect a 20 Amp plug 802 to a 30 Amp connector 804. FIG. 8A shows a front view of the adapter nut and FIG. 8D shows a rear view of the adapter nut 800. FIG. 8B shows a side view of the adapter nut 800 and FIG. 8C shows a cross-section view of FIG. 8B taken along Section line A-A. FIGS. 8E and 8F show perspective views of the adapter nut 800. FIG. 8G shows an adapter nut 800 connecting a plug 802 and connector 804 providing a rigid, watertight assembly.

Advantages of this design include but are not limited to an adapter assembly that has a simple waterproof design including a waterproof adapter nut. The waterproof adapter nut in accordance with the present invention enables the adapter assembly to endure prolonged exposure to the weathering elements and to protect the user from incidental contact with the enclosed electrical equipment.

All the features disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

What is claimed is:

1. An adapter nut having a first opening sized to accept one end of a plug and a second opening sized to accept one end of a connector.

2. The adapter nut recited in claim 1, wherein the adapter nut is waterproof.

3. The adapter nut recited in claim 1, wherein the first opening of the waterproof adapter nut includes threads at least on its interior surface for connection to a threaded plug and wherein the second opening of the waterproof adapter nut includes threads at least on its interior surface for connection to a threaded connector.

4. An adapter assembly comprising:
a plug;
a power cable coupled to the plug;
a waterproof adapter nut, having a first opening and a second opening, the first opening coupled to the plug, wherein the power cable extends through the first and second opening of the waterproof adapter nut;
a connector coupled to the second opening of the adapter nut, wherein the power cable extends through the connector; and
a receptacle coupled to the power cable and the connector.

5. The adapter assembly recited in claim 4, wherein the first opening of the waterproof adapter nut includes threads at least on its interior surface for connection to a threaded plug and wherein the second opening of the waterproof adapter nut includes threads at least on its interior surface for connection to a threaded connector.

6. The adapter assembly recited in claim 4, wherein the plug, having a current rating of 30 amps and the connector having a current rating of 20 amps.

7. The adapter assembly recited in claim 4, wherein the plug, having a current rating of 15 amps and the connector having a current rating of 15 amps.

8. The adapter assembly recited in claim 4, wherein the plug, having a current rating of 15 amps and the connector having a current rating of 20 amps.

9. The adapter assembly recited in claim 4, wherein the plug, having a current rating of 15 amps and the connector having a current rating of 30 amps.

10. The adapter assembly recited in claim 4, wherein the plug, having a current rating of 20 amps and the connector having a current rating of 20 amps.

11. The adapter assembly recited in claim 4, wherein the plug, having a current rating of 20 amps and the connector having a current rating of 30 amps.
